(19) United States
(12) Patent Application Publication
(10) Pub. No.: US 2017/0154355 A1
(43) Pub. Date: Jun. 1, 2017

(54) SCORE BOARDS BASED ON SOCIAL GROUPS

(71) Applicant: Google Inc., Mountain View, CA (US)

(72) Inventors: Benjamin A. Staffin, Mountain View, CA (US); Frances B. Haugen, Mountain View, CA (US)

(73) Assignee: Google Inc., Mountain View, CA (US)

(21) Appl. No.: 14/134,928

(22) Filed: Dec. 19, 2013

Related U.S. Application Data
(60) Provisional application No. 61/792,207, filed on Mar. 15, 2013.

(51) Int. Cl. G06Q 30/02

(52) U.S. Cl. CPC G06Q 30/0242

(57) ABSTRACT

Methods, systems, and apparatus include computer programs encoded on a computer-readable storage medium for providing content. A method includes: identifying a plurality of segments of viewers wherein each segment is associated with an entity; identifying pairs of segments for comparison; responsive to a request for content, identifying a content item for presentation on a user device; identifying a first pair of segments that are associated with the content item; determining, for each segment of the first segment pair, a response metric associated with responses to the content item, the responses attributable to entities in a given segment; and providing the content item responsive to the request including providing results associated with the response metric for both segments of the first pair of segments for presentation along with the content item.

### CROSS-REFERENCE TO RELATED APPLICATION

This application claims the benefit of the U.S. Provisional Application Ser. No. 61/792,207, filed on Mar. 15, 2013, the entire contents of which are hereby incorporated by reference.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Slots can be allocated to content sponsors through a reservation system or an auction. For example, content sponsors can provide bids specifying amounts that the sponsors are respectively willing to pay for presentation of their content. In turn, a reservation can be made or an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a method for providing content. The method comprises: identifying a plurality of segments of viewers wherein each segment is associated with an entity; identifying pairs of segments for comparison; responsive to a request for content, identifying a content item for presentation on a user device; identifying a first pair of segments that are associated with the content item; determining, for each segment of the first segment pair, a response metric associated with responses to the content item, the responses attributable to entities in a given segment; and providing the content item responsive to the request including providing results associated with the response metric for both segments of the first pair of segments for presentation along with the content item.

In general, another innovative aspect of the subject matter described in this specification can be implemented in methods that include a method for providing content. The method includes: identifying a content item for presentation responsive to a request from a device; determining a pair of segments of viewers that have been associated with the content item, wherein the pair includes rivals; determining interaction data for the content item attributable to entities in respective segments of the pair; and providing the content item along with comparison information based at least in part on the interaction data.

In general, another innovative aspect of the subject matter described in this specification can be implemented in systems. A system includes: one or more processors; and one or more memory elements including instructions. The instructions, when executed, cause the one or more processors to: identify a plurality of segments of viewers wherein each segment is associated with an entity; identify pairs of segments for comparison; responsive to a request for content, identify a content item for presentation on a user device; identify a first pair of segments that are associated with the content item; determine, for each segment of the first segment pair, a response metric associated with responses to the content item, the responses attributable to entities in a given segment; and provide the content item responsive to the request including providing results associated with the response metric for both segments of the first pair of segments for presentation along with the content item.

In general, another innovative aspect of the subject matter described in this specification can be implemented in computer program products. A computer program product is tangibly embodied in a computer-readable storage device and comprises instructions. The instructions, when executed by a processor, cause the processor to: identify a plurality of segments of viewers wherein each segment is associated with an entity; identify pairs of segments for comparison; responsive to a request for content, identify a content item for presentation on a user device; identify a first pair of segments that are associated with the content item; determine, for each segment of the first segment pair, a response metric associated with responses to the content item, the responses attributable to entities in a given segment; and provide the content item responsive to the request including providing results associated with the response metric for both segments of the first pair of segments for presentation along with the content item.

These and other implementations can each optionally include one or more of the following features. The plurality of segments can be or include social groups. A portion of the plurality of segments can include one or more segments associated with a respective geographic region. The pairs can include rivals. The content item can be associated with a campaign and the selection criteria for presenting the content item can include criteria that specifies the first pair of segments. A report can be provided to a content sponsor of the content item that includes interaction data related to the content item for entities associated with the first pair of segments. Providing results can include providing interaction data for members of each segment of the first pair of segments associated with interactions with the content item. Providing results can include providing a scoreboard presentation that includes the interaction data along with a designator for each respective segment of the first pair of segments. Selection criteria that specify the first pair of segments can be received from a content sponsor of the content item. The received selection criteria can be stored in a campaign associated with the first content item. Prior to receipt of the selection criteria, suggestions can be provided to the content sponsor of potential pairs of segments for comparison. Receiving a selection criteria can include receipt of one of the suggestions.

In general, another aspect of the subject matter described in this specification can be implemented in methods that include a method for providing content. The method comprises: identifying a content item for presentation responsive to a request from a device; determining a pair of segments of viewers that have been associated with the content item, wherein the pair includes rivals; determining interaction data for the content item attributable to entities in respective segments of the pair; and providing the content item along with comparison information based at least in part on the interaction data.

Particular implementations may realize none, one or more of the following advantages. A content provider can increase user interaction with content items when utilizing social-group based content items. Similarly, a content provider can increase engagement with users. Users can participate in interesting, social-group based activities. A content provider can be provided with information detailing user interaction with social-group based content items.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for providing content to a user.

FIG. 2 illustrates an example system for serving content.

FIGS. 3A and 3B illustrate example campaign management user interfaces.

FIG. 4 is a flowchart of an example process for providing content.

FIG. 5 is a flowchart of an example process for providing content.

FIG. 6 is a block diagram of computing devices that may be used to implement the systems and methods described in this document, as either a client or as a server or plurality of servers.

Like reference numbers and designations in the various drawings indicate like elements.

### DETAILED DESCRIPTION

A content item can be identified for presentation in response to a request for content from a user device. A pair of segments of viewers that have been associated with the content item can be identified. The pair can be, for example, a rival pair of social entities, such as two schools which compete in a rivalry. The pair can also be some other pair of social identity groups. Interaction data can be determined for the content item that is attributable to respective entities. The interaction data can indicate, for example, how often users associated with the respective entities have selected the content item. The content item and other information can be presented on the user device. For example, comparison information, such as a scoreboard that includes selection counts for each entity, can be presented along with the content item.

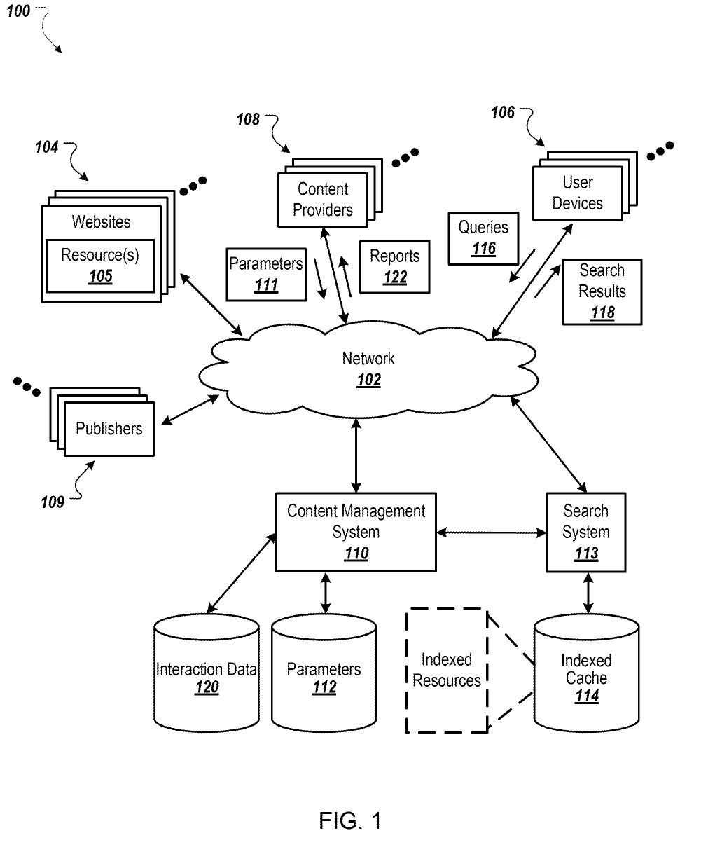

FIG. 1 is a block diagram of an example environment 100 for providing content to a user. The example environment 100 includes a network 102, such as a local area network (LAN), a wide area network (WAN), the Internet, or a combination thereof. The network 102 connects websites 104, user devices 106, content providers 108, publishers 109, and a content management system 110. The example environment 100 may include many thousands of websites 104, user devices 106, content providers 108, and publishers 109. The content management system 110 may be used for selecting and providing content in response to requests for content. The content providers 108 can be, for example, advertisers. Other types of content providers are possible.

A content provider 108 or content sponsor can create a content campaign associated with one or more content items using tools provided by the content management system 110. For example, the content management system 110 can provide one or more account management user interfaces for creating and managing content campaigns. The account management user interfaces can be made available to the content provider 108, for example, either through an online interface provided by the content management system 110 or as an account management software application installed and executed locally (or in association with a service requested by or) at a content provider's client device.

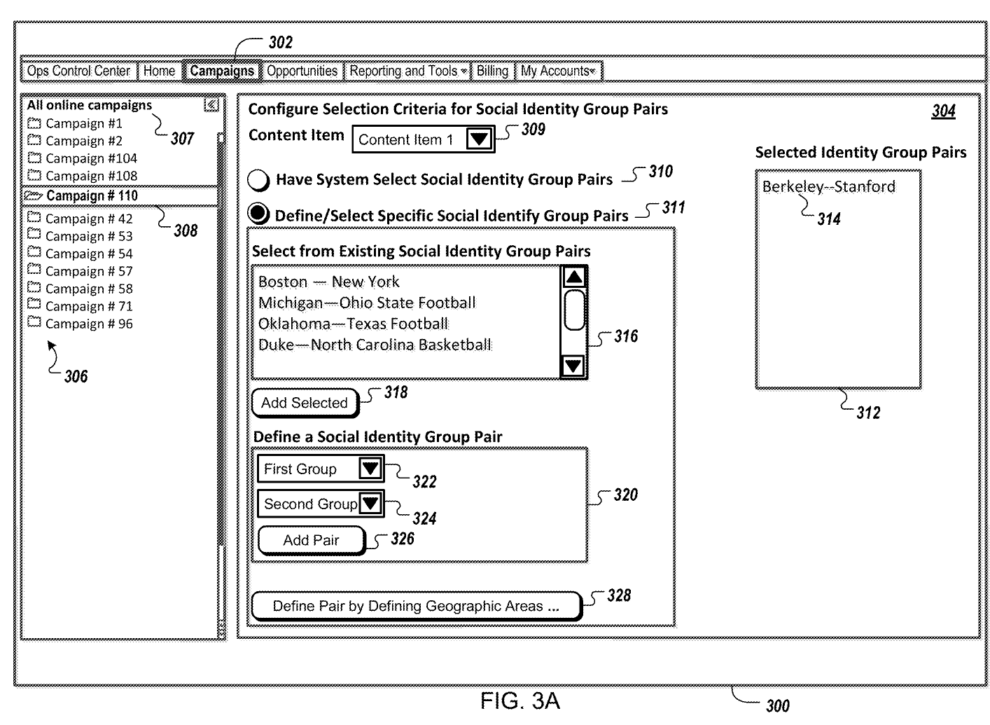

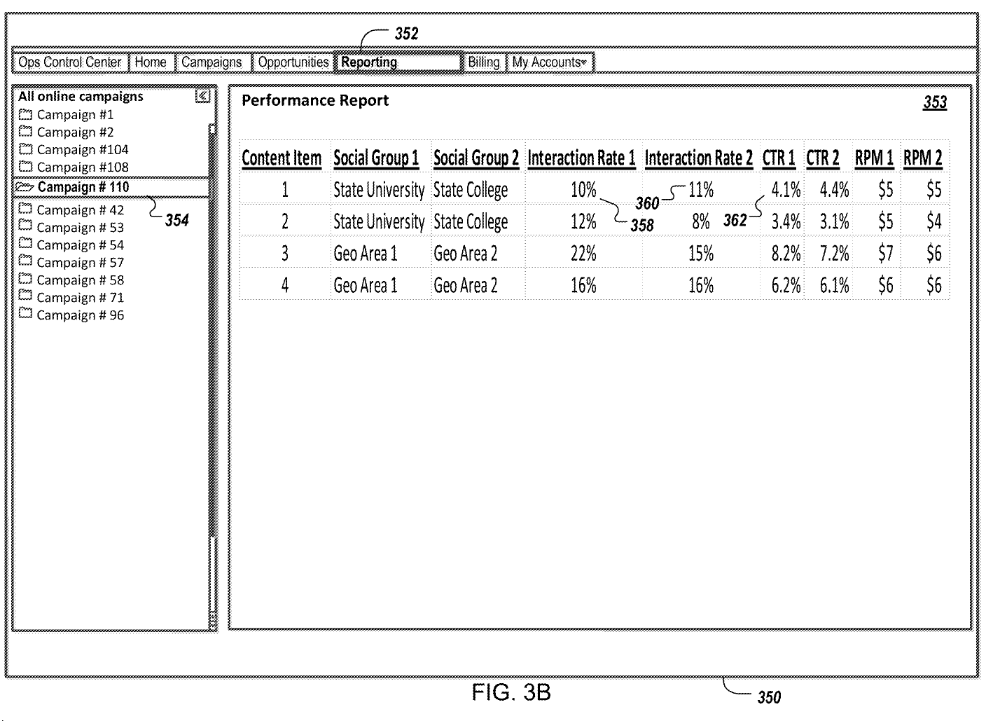

The content provider 108 can, using the account management user interfaces, provide campaign parameters 111 which define the content campaign. The campaign parameters 111 can be stored in a parameters data store 112. Campaign parameters 111 can include, for example, a campaign name, a budget for the campaign, start and end dates for the campaign, a schedule for content placements, content (e.g., a creatives), and selection criteria. Selection criteria can include, for example, a language, one or more geographical locations or target websites, and one or more keywords. The content campaign can be created and activated for the content provider 108 according to the parameters 111 specified by the content provider 108. As described in more detail below with respect to FIG. 3A, the content provider 108 can use an account management user interface to configure selection criteria that include social identity group pairs.

A website 104 includes one or more resources 105 associated with a domain name and hosted by one or more servers. An example website 104 is a collection of web pages formatted in hypertext markup language (HTML) that can contain text, images, multimedia content, and programming elements, such as scripts. Each website 104 can be maintained by a publisher 109, which is an entity that controls, manages and/or owns the website 104.

A resource 105 can be any data that can be provided over the network 102. A resource 105 can be identified by a resource address that is associated with the resource 105. Resources 105 include HTML pages, word processing documents, portable document format (PDF) documents, images, video, and news feed sources, to name only a few. The resources 105 can include content, such as words, phrases, videos, images and sounds, that may include embedded information (such as meta-information hyperlinks) and/or embedded instructions (such as JavaScript scripts).

To facilitate searching of resources 105, the environment 100 can include a search system 113 that identifies the resources 105 by crawling and indexing the resources 105 provided by the content publishers on the websites 104. Data about the resources 105 can be indexed based on the resource 105 to which the data corresponds. The indexed and, optionally, cached copies of the resources 105 can be stored in an indexed cache 114.

A user device 106 is an electronic device that is under control of a user and is capable of requesting and receiving resources 105 over the network 102. Example user devices 106 include personal computers, mobile communication devices (e.g., smartphones), and other devices that can send and receive data over the network 102. A user device 106 typically includes one or more user applications, such as a web browser, to facilitate the sending and receiving of data over the network 102.

A user device 106 can, for example, request resources 105 from a website 104. In turn, data representing the resource 105 can be provided to the user device 106 for presentation by the user device 106. As another example, user devices 106 can submit search queries 116 to the search system 113 over the network 102.

In response to a search query 116, the search system 113 can access the indexed cache 114 to identify resources 105 that are relevant to the search query 116. The search system 113 identifies the resources 105 in the form of search results 118 and returns the search results 118 to the user devices 106 in one or more search results pages. In some implementations, a search result 118 is data generated by the search system 113 that identifies a resource 105 that is responsive to a particular search query 116, and includes a link to the resource 105. An example search result 118 can include a web page title or video title, a snippet of text or a portion of an image extracted from the web page or video, and the URL (Unified Resource Location) of the web page.

A request for content can be received by the content management system 110 from a user device 106. The request for content can be associated with, for example, a request for a resource 105 or a search query 116. The content management system 110 can select one or more content items to provide in response to the request. For example, the request for content can include characteristics (e.g., size, supported media types) of one or more content “slots” that are defined for the requested resource 105 or search results page. As another example, resource keywords associated with a requested resource 105 or a search query 116 can be provided to the content management system 110. Content items selected by the content management system 110 can include content items having characteristics matching the characteristics of content slots and that are identified as relevant to specified resource keywords or search queries 116. For example, content items having selection keywords that match the resource keywords or the search query 116 can be selected by the content management system 110. The content management system 110 can also select content items at least in part based on the results of an auction.

In some implementations, some content providers 108 prefer that the number of impressions allocated to their content and the price paid for the number of impressions be more predictable than the predictability provided by an auction. A content provider 108 can increase the likelihood that its content receives a desired or specified number of impressions, for example, by entering into an agreement with a publisher 109, where the agreement requires the publisher 109 to provide at least a threshold number of impressions (e.g., 1,000 impressions) for a particular content item provided by the content provider 108 over a specified period (e.g., one week). In turn, the content provider 108, publisher 109, or both parties can provide data to the content management system 110 that enables the content management system 110 to facilitate satisfaction of the agreement.

For example, the content provider 108 can upload a content item and authorize the content management system 110 to provide the content item in response to requests for content corresponding to the website 104 of the publisher 109. Similarly, the publisher 109 can provide the content management system 110 with data representing the specified time period as well as the threshold number of impressions that the publisher 109 has agreed to allocate to the content item over the specified time period. Over time, the content management system 110 can select content items based at least in part on a goal of allocating at least a minimum number of impressions to a content item in order to satisfy a delivery goal for the content item during a specified period of time.

As described in more detail below, after identifying a content item for presentation in response to a request from a user device 106, the content management system 110 can determine a pair of segments of users that have been associated with (e.g., previously interacted with) the content item. The pair can, for example, be a rival pair of social entities or some other pair of social identity groups. The content management system 110 can determine interaction data for the content item from an interaction data store 120, where the interaction data is attributable to entities in respective segments of the identified pair. The content management system 110 can provide the content item along with comparison information that is based at least in part on the interaction data. For example, the content item can include a scoreboard which indicates a number of users in each segment who have interacted with the content item. If the user interacts with the presented content item, such as by voting or otherwise designating the content item in association with a particular social entity, the interaction data store 120 can be updated to account for the interaction. The content provider 108 can be presented one or more reports 122 which can include metrics related to user interaction with content items that include information for pairs of social entities, including metrics specific to individual entities.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to receive content from the content management system 110 that may be more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by the content management system 110 or other server.

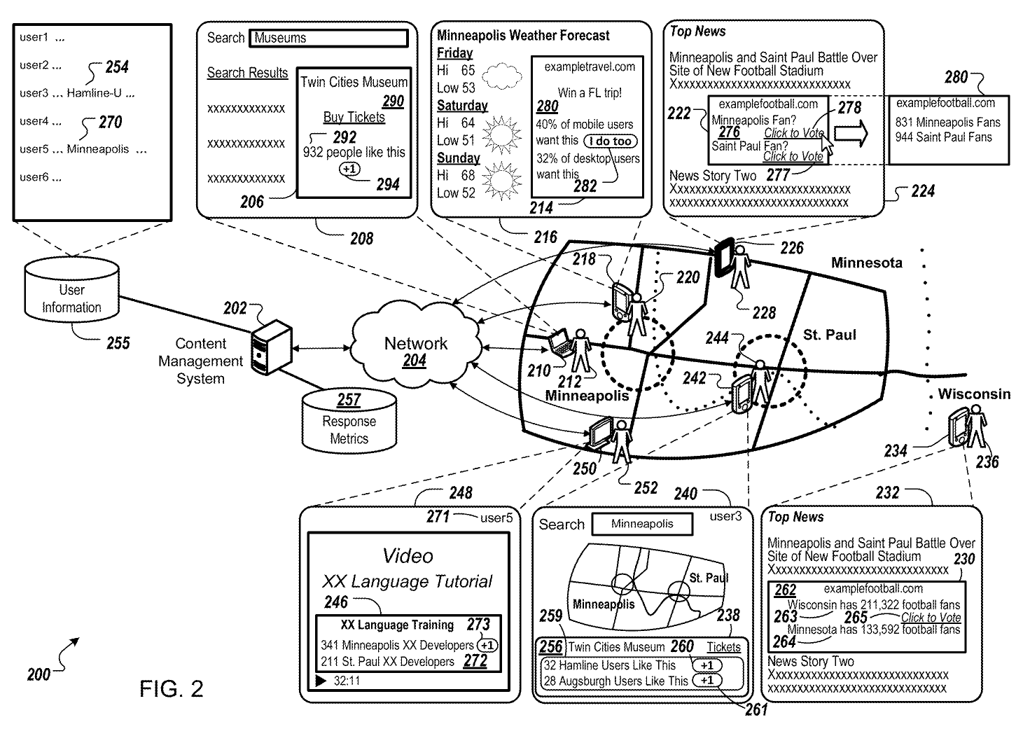

FIG. 2 illustrates an example system 200 for serving content. User devices can submit requests for content to a content management system 202 over a network 204. For example, the following requests can be received by the content management system 202: 1) a request for content for a content slot 206 included in a search results page 208 presented on a laptop device 210 of a user 212 who is located west of Minneapolis, Minn.; 2) a request for content for a content slot 214 included in a weather forecast page 216 presented on a mobile device 218 of a user 220 who is located in Minneapolis; 3) a request for content for a content slot 222 included in a news page 224 presented on a tablet device 226 of a user 228 who is located north of Minneapolis; 4) a request for content for a content slot 230 included in a news page 232 presented on a mobile device 234 of a user 236 who is located in Wisconsin; 5) a request for content for a content slot 238 included in a map interface 240 presented on a mobile device 242 of a user 244 who is located in Saint Paul. Minn.; and 6) a request for content for a content slot 246 included in a video player interface 248 presented on a desktop device 250 of a user 252 who is located south of Minneapolis.

In response to the request for content for the content slot 238, the content management system 202 can identify a pair of social identity groups that includes Hamline University (which is located in St. Paul, Minn.) and Augsburg College (located in Minneapolis, Minn.). The pair including Hamline and Augsburg is an example of a college rivalry. The Hamline-Augsburg pair can be identified, for example, based at least in part on both Hamline and Augsburg being associated with the content displayed in the map interface 240 (e.g., an area displayed in the map includes both Hamline and Augsburg).

As another example, the Hamline-Augsburg pair can be identified based at least in part on the user 244 being located in the same city (St. Paul) that is associated with the Hamline social identity group. As yet another example, the Hamline-Augsburg pair can be identified based on profile information 254 for the user 244 from a user information database 255. The Hamline-Augsburg pair can also be identified based on both Hamline and Augsburg being associated with a content item 256 that the content management system 202 selects for presentation in the content slot 238 (e.g., both Hamline and Augsburg are physically located in the Twin Cities and the content item 256 is a Twin Cities-related content item). The content item 256 can be selected based on the content displayed in the map interface 240, based on information about the user 244, based on the identified social identity group pair, and or on other factors. While reference is made here that the two entities for comparison are selected based on their proximate location, other factors can be used to determine which entities to compare. In some implementations, the content sponsor can specify the entities (e.g., rivals).

The content management system 202 can determine a response metric (e.g., from a response metrics database 257) associated with the content item 256 for both Hamline and Augsburg, where each response metric indicates responses that are attributable to users associated with a respective entity. The response metric information can be included in (e.g., presented with) the content item 256, such as on a scoreboard 259. For example, the scoreboard 259 indicates that thirty two Hamline users and twenty eight Augsburg users have designated (e.g., “liked”) the content item 256. The scoreboard 259 includes controls 260 and 261 (e.g., “plus-one” controls) which allow the user 244 to designate (e.g., “vote for”) either Hamline or Augsburg, respectively. The control 260 can be dynamically placed on top of the control 261 in response to the content management system 202 determining that the user 244 is associated with Hamline (e.g., based on the profile information 255). If the user selects the control 260 or the control 261, the corresponding Hamline or Augsburg count can be updated on the scoreboard 259 and a response metric associated with the selected entity and with the scoreboard 259 can be updated (e.g., incremented) in the response metrics database 257.

In response to the request for content for the content slot 230, the content management system 202 can identify a pair of social identity groups that includes users from the states of Minnesota and Wisconsin, respectively (e.g., a “MN-WI pair”). The MN-WI pair can be identified, for example, based at least in part on the user 236 being physically located in the state of Wisconsin. As another example, the MN-WI pair can be identified based on the content of the news page 232 being related to the state of Minnesota. The content management system 262 can identify a content item 262 for presentation in the slot 230 (e.g., based at least in part on football content of the content item 262 matching football content displayed in the news page 230).

The content management system 202 can determine response metrics that are associated with the content item 262 and with Wisconsin and Minnesota, respectively, and can present the response metrics along with the content item 262. For example, the content item 262 includes content 263 that indicates that 211,322 football fans have indicated that they are fans from Wisconsin and content 264 that indicates that 133,952 football fans have indicated that they are fans from Minnesota. The content item 262 includes a link 265 which allows the user 236 to indicate that they are a football fan from Wisconsin. The link 265 can be included without including a corresponding link for Minnesota, for example, based on the user 236 being physically located in Wisconsin, or based on other information associated with the user 236.

In another example, in response to the request for content for the content slot 246, the content management system 202 can identify a pair of social identity groups that includes users from the cities of Minneapolis and St. Paul, respectively. Although the content presented in the video player interface 248 is not related to either Minneapolis or St. Paul, the Minneapolis-St. Paul pair can be identified, for example, based on user profile information 270 that is associated with the user 252. The user 252 may, for example, be logged in to an account associated with the content management system 202 (e.g., as indicated by a user label 271).

The content management system 202 can identify a content item 272 for presentation in the content slot 246 and can determine a response metric for Minneapolis users and a response metric for St. Paul users where are each response metric is associated with the content item 272. For example, the content item 272 indicates that there are three hundred forty one “XX” programming language developers in Minneapolis and two hundred eleven “XX” programming language developers in St. Paul. The content item 272 includes a control 273, which allows the user 252 to indicate that they are an “XX” programming language developer from Minneapolis. The control 273 can be included without including a corresponding control for St. Paul, for example, based on the content management system 202 identifying the Minneapolis-related user profile information 270.

In another example, in response to the request for content for the content slot 222, the content management system 202 can identify a pair of social identity groups that includes users from the cities of Minneapolis and St. Paul, respectively. Although the user 228 is not physically located in either Minneapolis or St. Paul and does not have user profile information associated with either city, the content management system 202 can identify the Minneapolis-St. Paul pair, for example, based at least in part on the Minneapolis/St. Paul content of the news page 224. The content management system 202 can determine response metrics for each of Minneapolis and St. Paul where each response metric is associated with an identified content item 276. The content management system 202 can configure the content item 276 so that the response metrics are not initially displayed, but are presented in response to selection of a vote link 277 or a vote link 278 included in the content item 276. For example, in response to selection of the vote link 278, the content item 276 can be updated to include metrics which indicate the number of football fans in Minneapolis and St. Paul, respectively, as illustrated by an updated content item 280. The response metric for Minneapolis can include the vote associated with the selection of the link 278 by the user 226 and the response metrics database 257 can be updated in response to selection of the vote link 278.

Other types of entity pairs can be identified. In some implementations, any pair of entities that represents a dichotomy of users can be identified. For example, in response to the request for content for the content slot 214, the content management system 202 can identify a pair of social identity groups that includes mobile device users and desktop users (e.g., based on determining that the mobile device 218 is a mobile device). The content management system 202 can determine response metrics associated with an identified content item 280 for each of mobile device users and desktop users. For example, the content item 280 includes information that indicates that 40% of mobile users and 32% of desktop users have designated the content item 280. The content item 280 includes a control 282 that allows the user 220 to designate the content item 280 as a mobile user. The control 282 can be included in the content item 280 without including a corresponding control for desktop users based on the content management system 202 determining that the mobile device 218 is a mobile device.

In some implementations and for some requests for content, the content management system might not identify a pair of entities. For example, for the request for content for the content slot 206, the content management system might not determine a pair of social identity groups that are associated with content identified for the content slot 206, with the content presented in the search results page 208, or with the user 208, to name a few examples. In such a situation, the content management system 202 may identify some other pair of entities, such as a default pair of entities, or a random pair of entities. As another example, the content management system 202 may determine to present a content item that does not include response metrics for a pair of social identity groups. For example, the content management system 202 can identify a content item 290 which includes a single response metric 292 indicating a number of users who have designated the content item 290 and a control 294 which allows the user 208 to designate the content item 290.

FIG. 3A illustrates an example campaign management user interface 300. The user interface 300 can be included, for example, in one or more user interfaces that a user, such as a campaign sponsor, can use to configure a campaign. The sponsor can select a tab 302 to display a campaign configuration area 304. The sponsor can view a list 306 of campaigns by selecting a control 307. The sponsor can edit an existing campaign in the campaign configuration area 304 by selecting the name of an existing campaign (e.g., a name 308) in the campaign list 306.

The campaign configuration area 304 includes, among other controls, various controls which the sponsor can use to configure selection criteria that include entity (e.g., social identity group) pairings. The user can select one or more content items included in the campaign using a control 309. Content items listed in the control 309 can be template content items which include, for example, variable text which can be populated when the template content item is selected for presentation and after a pair has been associated with the template content item. For example, a template content item can include a scoreboard portion that has both static text and variable text, and the variable text can be populated with the names of entities and with interaction data that is associated with the entities. For example, a template content item may include a scoreboard area that includes two static labels that include the text “fans like this”. Upon selection of a pair, variable text including the name of a first entity in the pair and interaction data associated with the first entity can be added to the first static label to produce a first dynamic label, for example, of “388 Michigan fans like this”. Similarly, a second dynamic label can be generated corresponding to the second entity (e.g., such as “412 Ohio State fans like this”).

In some implementations, the campaign sponsor can designate different approaches for how a pair is associated with a template content item. For example, a pair can be selected, for example, based on a resource in which the template content item is to be presented and/or based on information associated with the user.

As another example, the user can select a control 311 to define or select a specific pair to be associated with the selected template content item(s). If the user selects the control 311, then the selected template content items are enabled to be selected for presentation, such as if a resource or a user associated with a request for content at least partially matches a pair selected or defined by the sponsor.

Entity pairs that have been selected or defined by the sponsor for the selected template content item(s) can be displayed in a control 312. For example, the sponsor has selected a pair 314 that represents a college rivalry between the University of California, Berkeley and Stanford University. The sponsor can use a control 316 to select one or more predefined pairs. For example, the control 316 enables selection of the following pairs: a geographic area rivalry pair including Boston and New York, a college football rivalry pair including Michigan and Ohio State, a college football rivalry pair including Oklahoma and Texas, and a college basketball rivalry pair including Duke and North Carolina. After selecting one or more pairs, the sponsor can select an add control 318 to associate the selected pair(s) with the campaign and to add the selected pair(s) to the control 312.

In some implementations, a group 320 of user interface controls can be used to define a new social identity group pair. For example, the sponsor can enter or select the name of a first social identity group using a control 322 and can enter or select the name of a second social identity group using a control 324. A new pair including the first group and the second group can be associated with the campaign and added to the control 312 by selecting an add control 326. In some implementations, the newly defined pair can be stored in a repository and used for subsequent population of the control 316 (e.g., in future presentations of the user interface 300 for the current sponsor or some other sponsor, the control 316 can include social identity group pairs previously defined using the user interface 300).

Pairs can be defined using methods other than selecting or entering names. For example, a sponsor can select a control 328 to cause display of a map interface (not shown) in which the sponsor can define pairs by defining or selecting two geographic areas (e.g., two cities, states, countries, neighborhoods, etc.). After dismissing the map interface, any pairs defined using the map interface can be displayed in the control 312 and associated with the selected template content item(s).

In some implementations, a sponsor can select a category of entities (e.g., “college basketball rivalries”). In some implementations, a sponsor can define and select a new category of entities. If a sponsor selects a category, a template content item may be selected, for example, for presentation on a resource that is associated with an entity that is of the type represented by the category. For example, if the sponsor associates the category “college basketball rivalries” with a content item, the content item may be selected to be presented on a news page that discusses a recent game for the University of Wisconsin Badgers basketball team. A pair that includes the University of Wisconsin Badgers basketball team may be selected (e.g., a rivalry between the University of Wisconsin Badgers and the University of Minnesota Gophers), and a scoreboard which includes interaction data for the two groups included in the pair may be presented along with the template content item.

Although the user interface 300 is illustrated as enabling one or more pairs to be associated with selected template content item(s) (e.g., either automatically by the content management system or by the user using the user interface 300), in some implementations, the sponsor can (e.g., using a different user interface, not shown) design a content item to be associated with one specific pair. For example, a content item can include a scoreboard portion that includes static text that includes the names of two entities that are included in a pair. The content management system, upon presentation of such a content item, can populate dynamic text with interaction information for the respective entities. Such a content item can be selected for presentation, for example, based at least in part on a resource or the user being associated with one or more of the entities that are associated with the content item.

FIG. 3B illustrates another example campaign management user interface 350. A campaign sponsor can select a reporting control 352 to view a performance report 353 for a selected campaign 354. The performance report 353 includes information for content items (e.g., content items one, two, three, and four) that are included in the campaign 354. For each respective content item included in the report 353, the report 353 indicates a pair of entities for which interaction data was presented (e.g., on a scoreboard) along with the content item. For example, the report 353 indicates that interaction data for “State University” and “State College” was presented with content item one. The performance report 353 can include one or more performance metrics for each content item, such as interaction rate (e.g., corresponding to interaction with voting buttons on a scoreboard), click through rate (CTR), and revenue per thousand impressions (RPM).

The performance metrics included in the performance report 353 can be grouped. For example, for content item one, a first interaction rate 358 of ten percent indicates that ten percent of users designated State University (e.g., voted for State University) when presented with content item one when content item one is included in a scoreboard including State University and State College. Similarly, for content item one, a second interaction rate 360 of eleven percent indicates that eleven percent of users designated State College when presented with content item one when content item one is included a scoreboard including State University and State College. As another example, the performance report 353 indicates, for content item one, a first click through rate 362 of 4.1 percent that is associated with State University. For example, the first click through rate 362 can indicate that 4.1 percent of users who voted for State University also selected (e.g., clicked through on) content item one to go to a landing page associated with content item one. As another example, the first click through rate 362 can indicate that 4.1 percent of users who are in general associated with State University selected content item one. A user can be associated with State University, for example, by voting for State University, being physically located at State University, by viewing a resource that is associated with State University but not with State College, having profile information that is associated with State University, or being associated with historical interaction history associated with State University.

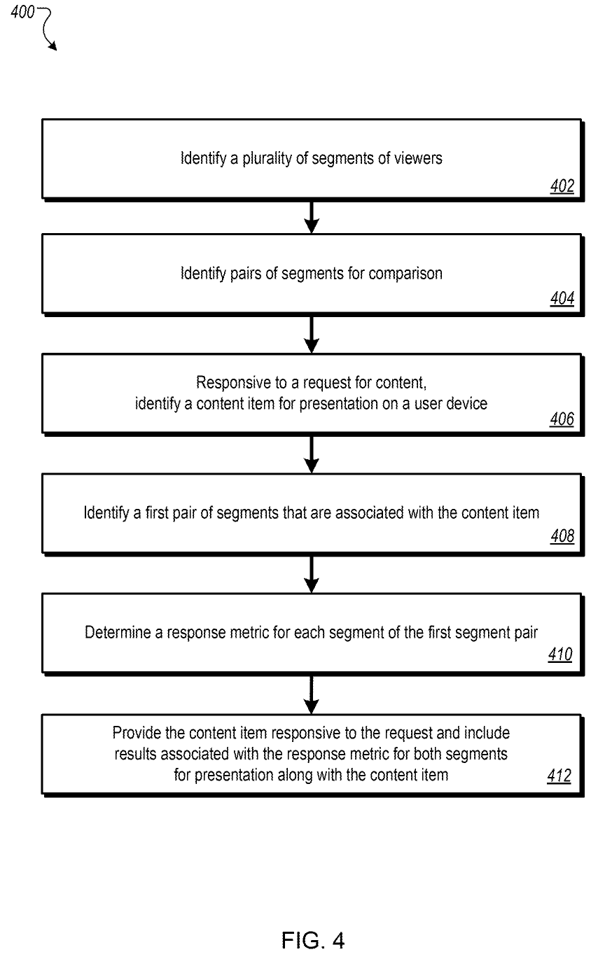

FIG. 4 is a flowchart of an example process 400 for providing content. The process 400 can be performed, for example, by the content management system 110 described above with respect to FIG. 1 or the content management system 202 described above with respect to FIG. 2.

A plurality of segments of viewers are identified (402), where each segment is associated with an entity. One example type of entity is a social identity group. In some implementations, a social identity group is a social group that an individual can belong to or have an affinity towards. For example, a social identity group can be associated with a geographic region, such as people living, working, or currently physically located in a particular city, state, neighborhood, country, or other geographic area. Numerous other social identity groups exist, such as students or alumni of a particular school, employees of a particular company, retired persons, men, women, and many others.

One or more pairs of segments are identified for comparison (404). A pair can, for example, include rivals. For example, a pair of segments can include two schools who are rivals in sporting and other competitions. As another example, a pair can include two rival geographic areas (e.g., two rival cities, neighborhoods, countries, or states). For example, Boston and New York can be a pair of rival geographic areas.

In general, a pair can include two segments which are related in some way, and where generally a user may be associated with one but not both of the social identity groups associated with the segments included in the pair. For example, for some pairs, each segment is generally (e.g., significantly) a converse of the other segment. For example, a pair can include stay-at-home parents and work-outside-the-home parents.

Responsive to a request for content, a content item is identified for presentation on a user device (406). For example, a content item can be identified that has characteristics matching a content slot associated with the request. The content item can be identified at least in part based on content of a resource which includes the content slot.

A first pair of segments that are associated with the content item is identified (408). For example, in some implementations, the content item is associated with a campaign and selection criteria for the campaign for presenting the content item include criteria that specify one or more pairs. If one or more pairs are specified in the selection criteria, a particular pair may be identified. The selection criteria can specify, for example, that the user or that a resource associated with the request be associated with one or both of the segments in a pair.

A response metric associated with responses to the content item is determined for each segment of the first segment pair (410), where the responses are attributable to entities in a given segment. Each response metric can include, for example, interaction data for members of a respective segment.

The content item is provided responsive to the request (412), including providing results associated with the response metric for one or both segments of the first pair of segments for presentation along with the content item. For example, a scoreboard presentation that includes interaction data along with a designator for each respective segment of the first pair of segments can be provided.

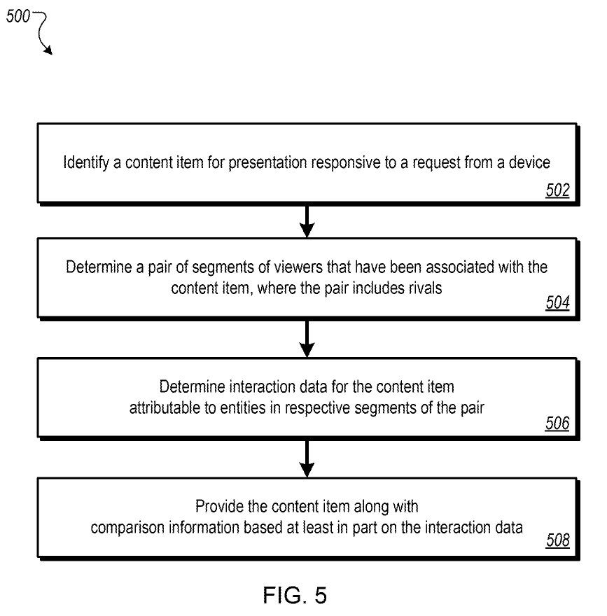

FIG. 5 is a flowchart of an example process 500 for providing content. The process 500 can be performed, for example, by the content management system 110 described above with respect to FIG. 1 or the content management system 202 described above with respect to FIG. 2.

A content item is identified for presentation responsive to a request from a device (502). For example, a content item can be identified that has characteristics matching a content slot associated with the request. The content item can be identified at least in part based on content of a resource which includes the content slot.

A first pair of segments of viewers that have been associated with the content item is determined (504), where the first pair includes a rival pair of social entities. The rival pair of social entities can include, for example, two competing schools, two rival geographic areas, or some other type of pair that represents a rivalry.

Interaction data attributable to entities in respective segments of the first pair to the content item is determined (506). For example, the interaction data can include data which indicates a number of users in each segment who have previously designated the content item.

The content item is provided along with comparison information based at least in part on the interaction data (508). For example, a scoreboard presentation that includes the comparison information can be provided. The scoreboard can include a control for each segment which allows a user to designate the content item in association with the segment that corresponds to a selected control.

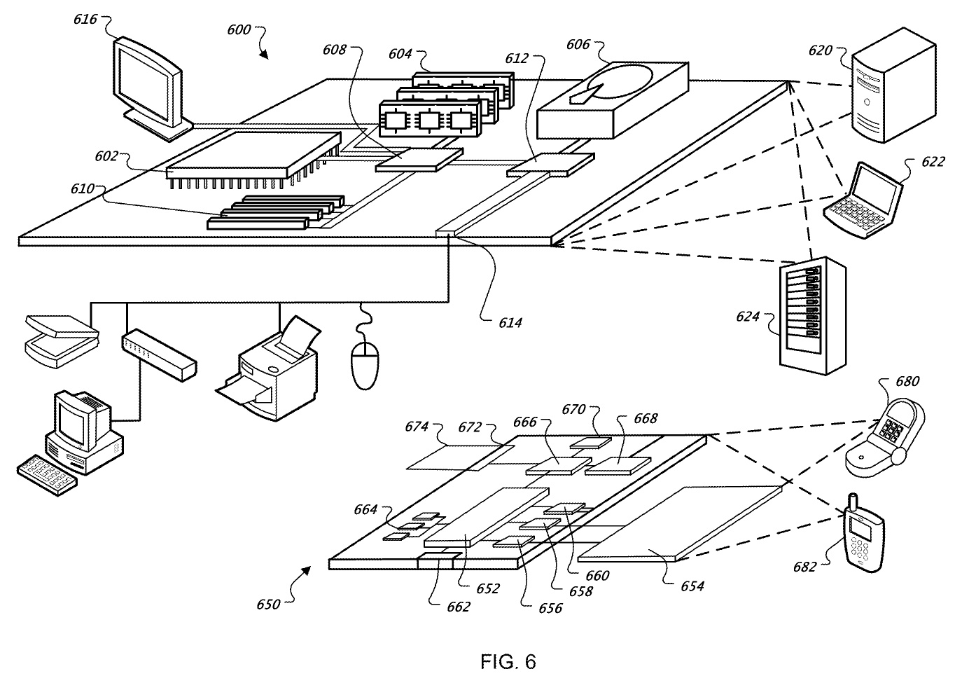

FIG. 6 is a block diagram of computing devices 600, 650 that may be used to implement the systems and methods described in this document, as either a client or as a server or plurality of servers. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a computer-readable medium. In one implementation, the memory 604 is a volatile memory unit or units. In another implementation, the memory 604 is a non-volatile memory unit or units.

The storage device 606 is capable of providing mass storage for the computing device 600. In one implementation, the storage device 606 is a computer-readable medium. In various different implementations, the storage device 606 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the computing device 600, while the low speed controller 612 manages lower bandwidth-intensive operations. Such allocation of duties is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can process instructions for execution within the computing device 650, including instructions stored in the memory 664. The processor may also include separate analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD display or an OLED display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication (e.g., via a docking procedure) or for wireless communication (e.g., via Bluetooth or other such technologies).

The memory 664 stores information within the computing device 650. In one implementation, the memory 664 is a computer-readable medium. In one implementation, the memory 664 is a volatile memory unit or units. In another implementation, the memory 664 is a non-volatile memory unit or units. Expansion memory 674 may also be provided and connected to device 650 through expansion interface 672, which may include, for example, a SIMM card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS receiver module 670 may provide additional wireless data to device 650, which may be used as appropriate by applications running on device 650.

Device 650 may also communication audibly using audio codec 660, which may receive spoken information from a user and convert it to usable digital information. Audio codex 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

861 To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”). and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A method comprising:
identifying a plurality of segments of viewers wherein each segment is associated with an entity;
identifying pairs of segments for comparison;
responsive to a request for content, identifying a content item for presentation on a user device;
identifying a first pair of segments that are associated with the content item;
determining, for each segment of the first segment pair, a response metric associated with responses to the content item, the responses attributable to entities in a given segment;
determining that a user associated with the user device is a member of one of the segments of the first segment pair;
in response to determining that the user is a member of the one of the segments of the first segment pair, modifying the content item to include a control that enables the user to increment the response metric associated with the one of the segments through interaction with the control that is included in the content item; and
providing the modified content item responsive to the request including providing results associated with the response metric for both segments of the first pair of segments for presentation along with the content item.

2. The method of claim 1 wherein the plurality of segments are social groups.

3. The method of claim 1 wherein a portion of the plurality of segments includes one or more segments associated with a respective geographic region.

4. (canceled)

5. The method of claim 1 wherein the content item is associated with a campaign and wherein selection criteria for presenting the content item include criteria that specifies the first pair of segments.

6. The method of claim 1 further comprising providing a report to a content sponsor of the content item that includes interaction data related to the content item for entities associated with the first pair of segments.

7. The method of claim 1 wherein providing results includes providing interaction data for members of each segment of the first pair of segments associated with interactions with the content item.

8. The method of claim 7 wherein providing results includes providing a scoreboard presentation that includes the interaction data along with a designator for each respective segment of the first pair of segments.

9. The method of claim 1 further comprising receiving from a content sponsor of the content item selection criteria that specify the first pair of segments.

10. The method of claim 9 further comprising storing the received selection criteria in a campaign associated with the first content item.

11. The method of claim 10 further comprising, prior to receipt of the selection criteria, providing suggestions to the content sponsor of potential pairs of segments for comparison wherein receiving a selection criteria includes receipt of one of the suggestions.

12. A method comprising;
identifying a content item for presentation responsive to a request from a device;
determining a pair of segments of viewers that have been associated with the content item, wherein the pair includes rivals;
determining interaction data for the content item attributable to entities in respective segments of the pair;
determining that a user associated with the device is a member of one of the segments of the pair of segments;
in response to determining that the user is a member of the one of the segments of the pair of segments, modifying the content item to include a control that enables the user to increment the response metric associated with the one of the segments of the pair of segments through interaction with the control that is included in the content item; and
providing the modified content item along with comparison information based at least in part on the interaction data.

13. A computer program product tangibly embodied in a computer-readable storage device and comprising instructions that, when executed by a processor, cause the processor to:
identify a plurality of segments of viewers wherein each segment is associated with an entity;
identify pairs of segments for comparison;
responsive to a request for content, identify a content item for presentation on a user device;
identify a first pair of segments that are associated with the content item;
determine, for each segment of the first segment pair, a response metric associated with responses to the content item, the responses attributable to entities in a given segment;
determine that a user associated with the user device is a member of one of the segments of the first segment pair;
in response to determining that the user is a member of the one of the segments of the first segment pair, modify the content item to include a control that enables the user to increment the response metric associated with the one of the segments through interaction with the control that is included in the content item; and
provide the modified content item responsive to the request including providing results associated with the response metric for both segments of the first pair of segments for presentation along with the content item.

14. The product of claim 13 wherein the plurality of segments are social groups.

15. The product of claim 13 wherein a portion of the plurality of segments includes one or more segments associated with a respective geographic region.

16. (canceled)

17. A system comprising:
one or more processors; and
one or more memory elements including instructions that when executed cause the one or more processors to:
identify a plurality of segments of viewers wherein each segment is associated with an entity;
identify pairs of segments for comparison;
responsive to a request for content, identify a content item for presentation on a user device;
identify a first pair of segments that are associated with the content item;
determine, for each segment of the first segment pair, a response metric associated with responses to the content item, the responses attributable to entities in a given segment;
determine that a user associated with the user device is a member of one of the segments of the first segment pair;
in response to determining that the user is a member of the one of the segments of the first segment pair, modify the content item to include a control that enables the user to increment the response metric associated with the one of the segments through interaction with the control that is included in the content item; and
provide the modified content item responsive to the request including providing results associated with the response metric for both segments of the first pair of segments for presentation along with the content item.

18. The system of claim 17 wherein the plurality of segments are social groups.

19. The system of claim 17 wherein a portion of the plurality of segments includes one or more segments associated with a respective geographic region.

20. (canceled)

21. The method of claim 1 wherein the control enables the user to designate the segment of the first segment pair with which the user is associated and does not enable the user to designate the other segment of the first segment pair.

22. The method of claim 1 further comprising:
receiving data indicating the user has responded to the content item; and
updating the response metric for the segment of the first segment pair that is associated with the user.

23. The method of claim 1 further comprising presenting a user interface to a content sponsor associated with the content item that enables the content sponsor to associate the segments of the first segment pair with the content item.
